(19) United States
(12) Patent Application Publication
(10) Pub. No.: US 2002/0013386 A1
(43) Pub. Date: Jan. 31, 2002

(54) Silicone-based pressure-sensitive adhesive composition

(75) Inventor: Shunji Aoki, Gunma-ken (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: Shin-Etsu Chemical Co., Ltd., Tokyo (JP)

(21) Appl. No.: 09/879,952

(22) Filed: Jun. 14, 2001

(30) Foreign Application Priority Data
Jun. 14, 2000 (JP) 2000-178564

(51) Int. Cl. C09J 4/00; C08F 283/00

(52) U.S. Cl. 523/176; 525/477

(57) ABSTRACT

The invention discloses a silicone-based pressure-sensitive adhesive composition which comprises, as a curing agent of a conventional silicone ingredient consisting of a diorganopolysiloxane and a so-called MQ siloxane resin, a 4,4′-dialkyl dibenzoyl peroxide or, in particular, 4,4′-dimethyl dibenzoyl peroxide instead of conventional organic peroxides such as dibenzoyl peroxide compounds. The inventive pressure-sensitive adhesive composition is advantageous in respect of the excellent adhesion performance which can be exhibited by curing under moderate conditions of temperature and time as compared with conventional silicone-based pressure-sensitive adhesive compositions.

### BACKGROUND OF THE INVENTION

The present invention relates to a novel silicone-based pressure-sensitive adhesive composition. More particularly, the invention relates to a silicone-based pressure-sensitive adhesive composition capable of being cured at a relatively low curing temperature and within a relatively short reaction time as compared with conventional pressure-sensitive adhesive compositions.

As is well known, silicone-based pressure-sensitive adhesive compositions are widely employed as an adhesive material in a great variety of pressure-sensitive adhesive tapes and labels by virtue of their excellent properties as compared with other types of pressure-sensitive adhesives such as acrylic and rubber-based adhesives in respects of heat resistance, cold resistance, weatherability, electric insulation and others enabling use of the pressure-sensitive adhesive tapes and labels under adverse environmental conditions in which other types of pressure-sensitive adhesives can no longer be serviceable due to denaturation or degradation.

These silicone-based pressure-sensitive adhesive tapes and labels are prepared generally by coating a backing film of a plastic resin and the like with a silicone-based pressure-sensitive adhesive composition to form an adhesive layer which is then subjected to a heat treatment to effect curing of the adhesive layer by crosslinking of the silicone constituent with an object to upgrade the behavior of pressure-sensitive adhesion.

While two types of silicone-based pressure-sensitive adhesive compositions are known and under practical applications as classified relative to the types of the crosslinking reaction, those currently under practical applications are of the so-called peroxide-curable type in which an organic peroxide such as dibenzoyl peroxide serves as a curing agent for the silicone constituent comprising a diorganopolysiloxane having a straightly linear molecular structure consisting of di-functional siloxane units, referred to as the D units hereinafter, and an organopolysiloxane having a three-dimensional network structure, sometimes called an MQ siloxane resin, consisting of monofunctional siloxane units and tetrafunctional siloxane units, referred to as the M units and Q units, respectively, hereinafter.

The silicone-based pressure-sensitive adhesive composition of the other type is of the so-called addition-curable type comprising a straightly linear diorganopolysiloxane having silicon-bonded vinyl groups and an MQ siloxane resin and a diorganopolysiloxane having hydrogen atoms directly bonded to the silicon atoms in the molecule with further admixture of a reaction-controlling agent and a catalytic amount of a platinum compound which promotes the hydrosilation addition reaction between the silicon-bonded vinyl groups and the silicon-bonded hydrogen atoms. The adhesive composition of this type, however, has a problem in respect of the properties of the adhesive layer after curing that the adhesive layer has low flexibility and low tackiness of the surface as compared with the peroxide-curable silicone-based pressure-sensitive adhesive compositions.

The silicone-based pressure-sensitive adhesive compositions of the peroxide-curable type are also not free from problems and disadvantages. When dibenzoyl peroxide is employed as the peroxide curing agent therein, for example, the curing reaction of the adhesive layer on a backing plastic film must be conducted at a temperature of 150° C. or higher taking a reaction time of 5 to 10 minutes or even longer. These curing conditions are so immoderate that the peroxide-curable adhesive compositions can hardly be applied to films of certain plastic resins having relatively low heat resistance such as polyethylene terephthalate resins, polypropylene resins and the like. In addition, the peroxide-curable adhesive compositions have a further problem in respect of their poor workability in coating so that the coating velocity therewith on a plastic film cannot be high enough.

The above mentioned disadvantages of the peroxide-curable pressure-sensitive adhesive compositions due to their poor curing behavior can be overcome at least partly by replacing the dibenzoyl peroxide with 2,2′,4,4′-tetrachloro dibenzoyl peroxide with which the curing temperature can be lower than 150° C. Use of this chlorine-containing organic peroxide in a pressure-sensitive adhesive composition, however, involvers serious problems to be solved. When waste materials under disposal by incineration contains a substantial amount of adhesive tapes and labels by using such a chlorine-containing organic peroxide, the exhaust gases unavoidably contain dioxins which are notoriously harmful and toxic against human body due to suspected calcinogenicity, malformation and acute toxicity with a high rate of accumulation in the ecological system as well as the risk as an endocrinological disruption substance. Accordingly, use of a halogen-containing organic peroxide is very undesirable and should be avoided as far as possible.

In addition, pressure-sensitive adhesive tapes and labels prepared by using a silicone-based pressure-sensitive adhesive composition containing a halogen-containing organic peroxide such as 2,2′,4,4′-tetrachloro dibenzoyl peroxide cannot be used in an electric or electronic instrument or on a metal article due to remaining of a halogen compound as a decomposition product of the halogen-containing organic peroxide in the adhesive layer after curing to exhibit a corrosive effect or contamination. It is therefore eagerly desired to develop a novel silicone-based pressure-sensitive adhesive composition capable of being cured under mild curing conditions and free from the problems and disadvantages due to the use of a halogen- containing organic peroxide as the curing agent.

### SUMMARY OF THE INVENTION

The object of the present invention is therefore to provide a silicone-based pressure-sensitive adhesive composition capable of being cured under mild curing conditions of a relatively low curing temperature and a relatively short curing time and free from the problems and disadvantages due to the use of a halogen-containing organic peroxide as the curing agent from which no detrimental halogen-containing decomposition products are produced by thermal decomposition or by incineration of waste materials.

The silicone-based pressure-sensitive adhesive composition provided by the present invention comprises, as a uniform blend:

(A) 100 parts by weight of a silicone ingredient having pressure-sensitive adhesiveness which is a combination, either as a mixture or as a condensation product, of

(a) a diorganopolysiloxane represented by the general formula

R¹₂R²Si—O—(—R¹₂Si—O—)ₙ—SiR¹₂R², (1)

In which R¹ is a monovalent hydrocarbon group having 1 to 10 carbon atoms, R² is a hydroxyl group or R¹ and the subscript n is an average number not smaller than 500, and

(b) an organopolysiloxane consisting of monofunctional siloxane units of the formula R¹₃SiO_{0.5}, in which R¹ has the same meaning as defined above, and tetrafunctional siloxane units of the formula SiO₂ in a molar ratio of the monofunctional siloxane units to the tetrafunctional siloxane units in the range from 0.6 to 1.3,

the weight proportion of the diorganopolysiloxane (a) to the organopolysiloxane (b) being in the range from 80:20 to 20:80; and

(B) from 0.5 to 5.0 parts by weight of a 4,4′-dialkyl dibenzoyl peroxide represented by the general formula

R—Pn—CO—O—O—CO—Pn—R, (II)

In which each R is, independently from the other, an alkyl group having 1 to 12 carbon atoms and Pn is a 1,4-phenylene group, as a curing agent of the component (A).

Preferably, the organic peroxide as the component (B) in the inventive adhesive composition is 4,4′-dimethyl dibenzoyl peroxide expressed by the above given formula (II) in which the alkyl group denoted by R is a methyl group.

### DETAILED DESCRIPTION OF THE PREFERRED EMBODIMENTS

As is described above, the component (A), which is the silicone ingredient exhibiting adhesiveness in the adhesive composition, is a combination of two different kinds of organopolysiloxanes (a) and (b) in a weight proportion in the range from 80:20 to 20:80 either as a mixture of the two organopolysiloxanes or as a condensation reaction product therebetween.

The first organopolysiloxane (a) is a diorganopolysiloxane represented by the above given general formula (I) in which R¹ is a monovalent hydrocarbon group having 1 to 10 carbon atoms, R² is a hydroxyl group or R¹ and the subscript n is an average number not smaller than 500. The monovalent hydrocarbon group having 1 to 10 carbon atoms denoted by R¹ is exemplified by alkyl groups such as methyl, ethyl and butyl groups, cycloalkyl groups such as cyclohexyl group, alkenyl groups such as vinyl, allyl and hexenyl groups and aryl groups such as phenyl and tolyl groups as well as substituted hydrocarbon groups obtained by replacing a part or all of the hydrogen atoms in the above named unsubstituted hydrocarbon groups with substituent groups free from halogen atoms, e.g., hydroxyl groups, cyano groups, alkoxy groups and the like, such as 3-hydroxypropyl, 2-cyanoethyl and 2-methoxyethyl groups. It is preferable that the groups R¹ are selected from methyl and phenyl groups or it is more preferable that at least 50% by moles of the groups R¹ are methyl groups, the balance, if any, being phenyl groups.

While the viscosity of the diorganopolysiloxane as the organopolysiloxane (a) is closely correlated to the value of the subscript n in the general formula (I), it is preferable to use a diorganopolysiloxane having a viscosity of 10000 mPa·s or higher at 25° C. or having a gum-like consistency. Optionally, the organopolysiloxane (a) can be a combination of two different diorganopolysiloxanes each satisfying the above given definition.

The second organopolysiloxane (b) is a so-called MQ siloxane resin consisting of the monofunctional siloxane units and the tetrafunctional siloxane units in a molar proportion M:Q in the range from 0.6 to 1.3. When the M:Q ratio is too small, the adhesive layer of the pressure-sensitive adhesive composition suffers a decrease in the peel adhesion and surface tackiness while, when the ratio is too large, the pressure-sensitive adhesive composition suffers a decrease in the holding power. Preferably, the organopolysiloxane (b) has residual silanol groups. i.e. silicon-bonded hydroxyl groups, to give a hydroxyl content in the range from 0.3 to 4.0% by weight. It is of course optional that the organopolysiloxane (b) is a combination of two different MQ siloxane resins each satisfying the above given definition. When the component (A) is a simple mixture of the above described organopolysiloxanes (a) and (b), the mixing proportion of the two is in the range from 80:20 to 20:80 by weight or, preferably, from 70:30 to 30:70 by weight.

When these two organopolysiloxanes are used as the component (A) in the form of a condensation reaction product thereof instead of a simple mixture, the condensation reaction can be performed by dissolving the organopolysiloxanes (a) and (b) in an organic solvent and heating the solution with admixture of an alkaline compound as a catalyst although the reaction can proceed even at room temperature. A variety of organic solvents can be used for the purpose including aromatic hydrocarbon solvents such as toluene and xylene, aliphatic hydrocarbon solvents such as hexane and octane, ketone solvents such as methyl ethyl ketone and methyl isobutyl ketone, ester solvents such as ethyl acetate and isobutyl acetate and ether solvents such as diisopropyl ether and 1,4-dioxane as well as mixtures of these solvents. The weight proportion of the organopolysiloxanes (a) and (b) in conducting the condensation reaction is in the range from 20:80 to 80:20 or, preferably, from 30:70 to 70:30. When the component (A) is prepared by the condensation reaction of the organopolysiloxanes (a) and (b), each of these organopolysiloxanes should preferably have a substantial amount of silanolic hydroxyl groups.

The alkaline compound as the catalyst for the condensation reaction can be selected from alkali metal hydroxides such as sodium hydroxide and potassium hydroxide, alkali metal carbonates such as sodium carbonate, potassium carbonate and sodium hydrogencarbonate, alkali metal silanolates such as sodium silanolate and potassium silanolate, alkali metal alkoxides such as sodium methoxide and potassium methoxide, amine compounds such as triethylamine, diethylamine and aniline and gaseous ammonia or ammonia water. The amount of the catalytic alkaline compound in the reaction mixture is in the range from 10 to 10000 ppm by weight based on the total amount of the organopolysiloxanes (a) and (b). When the condensation reaction is conducted with an adequate formulation of the reaction mixture and at an adequate reaction temperature, the reaction is completed usually taking 1 to 20 hours.

The component (B) in the inventive pressure-sensitive adhesive composition is an organic peroxide to serve as a crosslinking agent for the component (A). The organic peroxide used in the invention is a 4,4′-dialkyl dibenzoyl peroxide represented by the general formula (II) given above, in which each of the groups denoted by R is, independently from the other, an alkyl group having 1 to 12 or, preferably, 1 to 4 carbon atoms exemplified by methyl, ethyl, propyl and isobutyl groups. A quite unexpected discovery leading to the present invention is that alkyl groups R essentially substitute the respective phenyl groups at the 4- and 4′-positions relative to the carbonyl groups and not at the 2- and 2′-positions or at the 3- and 3′-positions. When a silicone-based pressure-sensitive adhesive composition is prepared with a dialkyl dibenzoyl peroxide of which the alkyl substitution is not at the 4- and 4′-positions, curing of the adhesive composition does not proceed at a low temperature or within a short time.

The amount of the component (B) in the inventive pressure-sensitive adhesive composition is in the range from 0.5 to 5.0 parts by weight per 100 parts by weight of the silicone ingredient as the component (A). The compounding form of the component (B) with the component (A) is not particularly limitative including the peroxide compound as such, a solution prepared by dissolving the peroxide compound in a small volume of an organic solvent, an aqueous dispersion of the peroxide compound and a paste prepared by kneading the peroxide compound with a silicone oil.

It is of course optional that the silicone-based pressure-sensitive adhesive composition comprising the components (A) and (B) is further admixed with a variety of known additives conventionally employed in a pressure-sensitive adhesive composition including organic solvents, antioxidants, coloring agents and so on. When the silicone ingredient as the component (A) has a particularly high viscosity, dilution of the adhesive composition with an organic solvent is desirable in order to improve the application workability of the composition onto the surface of, for example, the backing film. Examples of the organic solvents suitable for this purpose include aromatic hydrocarbon solvents such as toluene and xylene, aliphatic hydrocarbon solvents such as hexane and octane, ketone solvents such as methyl ethyl ketone and methyl isobutyl ketone, ester solvents such as ethyl acetate and isobutyl acetate and ether solvents such as diisopropyl ether and 1 ,4-dioxane either singly or as a mixture of two kinds or more thereof.

The silicone-based pressure-sensitive adhesive composition of the present invention prepared according to the above described formulation can be applied by a suitable coating method onto the surface of a variety of backing materials such as paper sheets, plastic films and the like to form a coating layer which is subjected to a curing heat treatment to give a pressure-sensitive adhesive paper sheet, pressure-sensitive adhesive tapes and the like.

Examples of the backing materials to which the pressure-sensitive adhesive composition is applied to prepare a pressure-sensitive adhesive material include films of a plastic resin such as polyesters, polypropylenes, polyethylenes, polystyrenes, polyamides, polycarbonates, polytetrafluoroethylenes and polyphenylene sulfides, foils of a metal such as aluminum and copper, paper sheets such as cellulosic and synthetic paper sheets, woven and non-woven fabrics of cotton, flax and synthetic fibers and glass cloths as well as laminated sheets of a plurality of these web materials. It is sometimes advantageous that the surface of these sheet materials are subjected to a pre-treatment with a primer composition in order to improve adhesion between the surface of the backing material and the adhesive layer.

The coating thickness with the inventive pressure-sensitive adhesive composition on the above named backing materials is in the range from 1 to 200 μm as dried. It is advantageous that the coating layer of the pressure-sensitive adhesive composition is subjected to a heat treatment at a temperature of 100 to 200° C. for 30 seconds to 15 minutes to effect curing or to accomplish stable adhesive behavior of the adhesive layer. This heat treatment should be conducted not to cause curling of the adhesive-coated sheet material under the heat treatment.

In the following, the silicone-based pressure-sensitive adhesive composition of the present invention is described in more detail by way of Examples and Comparative Examples, which, however, never limit the scope of the invention in any way. In the following description, the term of “parts” always refers to “parts by weight”. The pressure-sensitive adhesive compositions prepared in the Examples and Comparative Examples were subjected to the evaluation tests for the items shown below by the respective testing procedures described there.

Gel fraction of the adhesive layer: A 25 μm thick polyethylene terephthalate tape of 25 mm width was coated with a 40% by weight toluene solution of the adhesive composition under testing in a coating amount to give a coating thickness of 40 μm after drying followed by a heat treatment for 5 minutes at 120° C., 140° C. or 160° C. to give a pressure-sensitive adhesive tape having a cured adhesive layer. The above mentioned curing conditions of the adhesive layer with the curing temperatures of 120° C., 140° C. and 160° C. are referred to hereinafter as the Curing 1, Curing 2 and Curing 3, respectively.

A 15 cm long portion of the thus prepared pressure-sensitive adhesive tape was immersed and kept in toluene at room temperature for 3 hours or longer to effect extraction of any toluene-soluble fraction in the adhesive layer followed by drying of the tape taken out of the toluene bath at 100° C. for 30 minutes. The weight W₁ or W₂ of the adhesive tape was determined before the toluene extraction and after the toluene extraction and drying, respectively. Thereafter, the remaining adhesive layer on the tape was completely removed and the weight W₀ of the thus uncoated tape per se was determined to calculate the gel fraction, %, in the adhesive layer as (W₂−W₀)/(W₁−W₀) (×100). A larger value of this gel fraction means that curing of the adhesive layer is more complete.

Holding power: A pressure-sensitive adhesive tape was prepared in just the same manner as in the measurement of the gel fraction described above. The adhesive tape was attached to the lower end portion of a vertically held, well polished stainless steel plate in a dangling fashion with a 25 mm by 25 mm wide adhesive bonding area. A load of 1 kg weight was added to the lower end of the dangling adhesive tape and the assembly of the plate, tape and weight was kept standing at 150° C. for 2 hours followed by a microscopic measurement of the distance of downward displacement of the tape. A smaller value of this distance means a higher holding power as a result of more complete crosslinking reaction.

Peel adhesion: A pressure-sensitive adhesive tape prepared in just the same manner as in the measurement of the gel fraction described above was attached to the well polished surface of a stainless steel plate and pressed with a rubber-clad roller of 2 kg weight moved once back and forth. After being kept standing for about 20 hours at room temperature, the adhesive tape was peeled off the stainless steel plate at room temperature on a tensile testing machine in a 180° peeling direction at a peeling velocity of 300 mm/minute to determine the peeling resistance per 25 mm width.

### EXAMPLE 1

A toluene solution of silicone was prepared by dissolving, in 40 parts of toluene, 60 parts of a condensation product obtained by conducting the condensation reaction in toluene between 30 parts of a dimethylpolysiloxane expressed by the structural formula Me₂(OH)Si—O—(—SiMe₂—O—)₅₀₀₀—Si(OH)Me₂, in which Me is a methyl group, and 30 parts of an MQ siloxane resin consisting of the monofunctional siloxane units of the formula Me₃SiO_{0.5} and the tetrafunctional siloxane units of the formula SiO₂ in a molar proportion of 0.7:1 and containing 1.3% by weight of silanolic hydroxyl groups. This silicone solution in an amount of 100 parts was admixed with 2.4 parts of a silicone oil paste containing 50% by weight of 4,4′-dimethyl dibenzoyl peroxide and 50 parts of toluene to give a silicone-based pressure-sensitive adhesive composition in the form of a toluene solution. The results of the evaluation tests of this adhesive composition are shown in Table 1 below for the curing conditions of Curing 1, Curing 2 and Curing 3.

### COMPARATIVE EXAMPLE 1

The experimental procedure was substantially the same as in Example 1 described above excepting for the replacement of the 4,4′-dimethyl dibenzoyl peroxide with the same amount of dibenzoyl peroxide. The results of the evaluation tests are shown in Table 1.

### COMPARATIVE EXAMPLE 2

The experimental procedure was substantially the same as in Example 1 described above excepting for the replacement of the 4,4′-dimethyl dibenzoyl peroxide with the same amount of 2,2′,4,4′-tetrachloro dibenzoyl peroxide. The results of the evaluation tests are shown in Table 1 excepting the peel adhesion.

### EXAMPLE 2

A toluene solution of silicone was prepared by dissolving, in 40 parts of toluene, 24 parts of a dimethylpolysiloxane expressed by the structural formula Me₂(OH)Si—O—(—SiMe₂—O—)₇₀₀₀—Si(OH)Me₂ and 36 parts of an MQ siloxane resin consisting of the monofunctional siloxane units of the formula Me₃SiO_{0.5} and the tetrafunctional siloxane units of the formula SiO₂ in a molar proportion of 0.8:1 and containing 1.3% by weight of the silanolic hydroxyl groups. This silicone solution in an amount of 100 parts was admixed with 2.4 parts of a silicone oil paste containing 50% by weight of 4,4′-dimethyl dibenzoyl peroxide and 50 parts of toluene to give a silicone-based pressure-sensitive adhesive composition in the form of a toluene solution. The results of the evaluation tests of this adhesive composition are shown in Table 1 below excepting the peel adhesion.

### COMPARATIVE EXAMPLE 3

The experimental procedure was substantially the same as in Example 2 described above excepting for the replacement of the 4,4′-dimethyl dibenzoyl peroxide with the same amount of dibenzoyl peroxide. The results of the evaluation tests are shown in Table 1 excepting the peel adhesion. When the curing time at 160° C. was extended to 10 minutes, the gel fraction was increased to 40% and the holding power was improved to 0.06 mm but the thus obtained adhesive tape was defective due to curling deformation.

### COMPARATIVE EXAMPLE 4

The experimental procedure was substantially the same as in Example 2 described above excepting for the replacement of the 4,4′-dimethyl dibenzoyl peroxide with the same amount of 3,3′-dimethyl dibenzoyl peroxide. The results of the evaluation tests are shown in Table 1 excepting the peel adhesion.

### COMPARATIVE EXAMPLE 5

The experimental procedure was substantially the same as in Example 2 described above excepting for the replacement of the 4,4′-dimethyl dibenzoyl peroxide with the same amount of 2,2′-dimethyl dibenzoyl peroxide. The results of the evaluation tests are shown in Table 1 excepting the peel adhesion.

### EXAMPLE 3

The experimental procedure was substantially the same as in Example 2 described above excepting for the replacement of the 4,4′-dimethyl dibenzoyl peroxide with the same molar amount of 4,4′-di(n-butyl) dibenzoyl peroxide. The results of the evaluation tests are shown in Table 1 excepting the peel adhesion.

### COMPARATIVE EXAMPLE 6

The experimental procedure was substantially the same as in Example 2 described above excepting for the replacement of the 4,4′-dimethyl dibenzoyl peroxide with 2.1 parts of 4,4′-(di-tert-butyl) di(cyclohexyloxycarbonyl) peroxide. The results of the evaluation tests are shown in Table 1 excepting the peel adhesion.

### COMPARATIVE EXAMPLE 7

The experimental procedure was substantially the same as in Example 2 described above excepting for the replacement of the 4,4′-dimethyl dibenzoyl peroxide with 1.9 parts of dilauroyl peroxide. The results of the evaluation tests are shown in Table 1 excepting the peel adhesion.

### COMPARATIVE EXAMPLE 8

The experimental procedure was substantially the same as in Example 2 described above excepting for the replacement of the 4,4′-dimethyl dibenzoyl peroxide with 1.4 parts of 1,1,3,3-tetramethylbutyl 2-ethyl 2-ethylhexyloyl peroxide expressed by the structural formula MeCMe₂CH₂CMe₂OOCOCHEt(CH₂)₃Me, in which Me is a methyl group and Et is an ethyl group. The results of the evaluation tests are shown in Table 1 excepting the peel adhesion.

TABLE 1

| | | Gel fraction, | Holding | Peel adhesion, |
|---|---|---|---|---|
| | Curing | % | power, mm | N/25 mm |
| Example 1 | 1 | 35 | 0.07 | 9.3 |
| | 2 | 47 | 0.04 | 9.3 |
| | 3 | 51 | 0.01 | 8.7 |
| Comparative | 1 | 7 | 1.23 | 9.3 |
| Example 1 | 2 | 34 | 0.16 | 9.4 |
| | 3 | 43 | 0.01 | 9.6 |
| Comparative | 1 | 36 | 0.06 | — |
| Example 2 | 2 | 49 | 0.03 | — |
| | 3 | 51 | 0.01 | — |
| Example 2 | 1 | 33 | 0.69 | — |
| | 2 | 37 | 0.09 | — |
| | 3 | 42 | 0.03 | — |
| Comparative | 1 | 0 | falling | — |
| Example 3 | 2 | 27 | 1.01 | — |
| | 3 | 39 | 0.08 | — |
| Comparative | 1 | 0 | 2.38 | — |
| Example 4 | 2 | 28 | 0.53 | — |
| | 3 | 37 | 0.11 | — |
| Comparative | 1 | 0 | falling | — |
| Example 5 | 2 | 26 | 1.01 | — |
| | 3 | 32 | 0.47 | — |
| Example 3 | 1 | 34 | 0.67 | — |
| | 2 | 38 | 0.10 | — |
| | 3 | 41 | 0.03 | — |
| Comparative | 1 | 5 | 0.97 | — |
| Example 6 | 2 | 39 | 0.87 | — |
| | 3 | 20 | falling | — |
| Comparative | 1 | 0 | falling | — |
| Example 7 | 2 | 0 | falling | — |
| | 3 | 0 | falling | — |
| Comparative | 1 | 0 | falling | — |
| Example 8 | 2 | 0 | falling | — |
| | 3 | 0 | falling | — |

As is understood from the experimental results shown in Table 1, the pressure-sensitive adhesive tapes prepared by using the inventive silicone based pressure-sensitive adhesive compositions formulated with a 4,4′-dialkyl dibenzoyl peroxide or, in particular, 4,4′-dimethyl dibenzoyl peroxide exhibit very superior performance as compared with similar pressure-sensitive adhesive tapes prepared by using conventional organic peroxide compounds as the curing agent of the composition.

What is claimed is:

1. A silicone-based pressure-sensitive adhesive composition which comprises, as a uniform blend:
(A) 100 parts by weight of a silicone ingredient which is a combination, either as a mixture or as a condensation product, of
(a) a diorganopolysiloxane represented by the general formula
R¹₂R²Si—O—(—R¹₂Si—O—)ₙ—SiR¹₂R²,
In which R¹ is a monovalent hydrocarbon group having 1 to 10 carbon atoms, R² is a hydroxyl group or R¹ and the subscript n is an average number not smaller than 500, and
(b) an organopolysiloxane consisting of monofunctional siloxane units of the formula R¹₃SiO_{0.5}, in which R¹ has the same meaning as defined above, and tetrafunctional siloxane units of the formula SiO₂ in a molar ratio of the monofunctional siloxane units to the tetrafunctional siloxane units in the range from 0.6 to 1.3,
the weight proportion of the diorganopolysiloxane (a) to the organopolysiloxane (b) being in the range from 80:20 to 20:80; and
(B) from 0.5 to 5.0 parts by weight of a 4,4′-dialkyl dibenzoyl peroxide represented by the general formula
R—Pn—CO—O—O—CO—Pn—R,
In which each R is, independently from the other, an alkyl group having 1 to 12 carbon atoms and Pn is a 1,4-phenylene group, as a curing agent of the component (A).

2. The silicone-based pressure-sensitive adhesive composition as claimed in claim 1 in which the alkyl group denoted by R in the component (B) has 1 to 4 carbon atoms.

3. The silicone-based pressure-sensitive adhesive composition as claimed in claim 1 in which the alkyl group denoted by R in the component (B) is a methyl group.

4. The silicone-based pressure-sensitive adhesive composition as claimed in claim 1 in which the weight proportion of the diorganopolysiloxane (a) to the organopolysiloxane (b) is in the range from 70:30 to 30:70.

5. The silicone-based pressure-sensitive adhesive composition as claimed in claim 1 in which the component (A) is a condensation product of the diorganopolysiloxane (a) and the organopolysiloxane (b).
